(19) United States
(12) Patent Application Publication
(10) Pub. No.: US 2010/0063876 A1
(43) Pub. Date: Mar. 11, 2010

(54) ALGORITHMIC CREATION OF VISUAL IMAGES

(75) Inventors: Kurt S. Godden, Sterling Heights, MI (US); Robert F. Bordley, Troy, MI (US); Theodore Costy, Warren, MI (US); Jonathan H. Owen, Beverly Hills, MI (US); David J. Vander Veen, Troy, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/543,967

(22) Filed: Aug. 19, 2009

Related U.S. Application Data
(60) Provisional application No. 61/095,984, filed on Sep. 11, 2008.

(51) Int. Cl. G06Q 30/00; G06T 11/20

(52) U.S. Cl. 705/14.43; 705/14.72; 705/14.45; 345/441

(57) ABSTRACT

A system and method for automatically creating an image. In one non-limiting embodiment, the image is created for an advertisement that may be targeted to an individual. The method includes identifying image input parameters that the image will be based on, such as a particular product to display, a specific viewer of the image, etc. The method selects image elements from a database of image elements, such as backgrounds, messages, animation, etc., based on the image parameters. The method then creates the image using the image elements where the design and creation of the image is subject to certain rules and constraints that must be followed, such as font size, color schemes, etc.

### CROSS-REFERENCE TO RELATED APPLICATIONS

This application claims the benefit of the priority date of U.S. Provisional Patent Application Ser. No. 61/095,984, titled Algorithmic Creation of Visual Images, filed Sep. 11, 2008.

### BACKGROUND OF THE INVENTION

1. Field of the Invention

This invention relates generally to a system and method for automatically creating an image and, more particularly, to a system and method for automatically creating a visual image that includes using certain input parameters to select image elements from a database to create the image, where creation of the image is subject to predetermined rules and constraints.

2. Discussion of the Related Art

Certain industries spend a considerable effort developing advertisements targeting potential customers. The advertising budget for automobile manufacturers, for example, is typically very high and is a considerable percentage of the actual vehicle cost, so that the ads reaches a large percentage of the population. Advertising is provided in any suitable media, such as television, print, radio, Internet, billboards, streaming media, etc.

A typical process for developing an advertisement for a particular vehicle includes a group of advertising personnel meeting to discuss the product itself and the types of ads that may be suitable for the product. Once an idea is developed from this discussion, it is prototyped and presented to the company to determine whether it is acceptable for that product. Once the advertisement is accepted and produced, it is distributed in a suitable medium, typically as a mass marketing campaign that reaches a large number of people. The trend, however, has been for the development of more advertisements that are reaching fewer people who are paying less attention to the ads due to new technologies, such as digital video recorders, which allow skipping of advertising. Further, advertising budgets are typically shrinking, while advertising needs are increasing.

Various advertisements in the print media, on websites and in other mediums generally include images associated with the advertisement that are intended to appeal to potential customers. These images can be more specifically defined for a particular person or group of persons by selecting image elements that may better appeal to those persons.

Currently, some image generating techniques are performed by algorithms that automatically create the images. However, these known techniques for automatically creating images typically have been limited to processes that fill in templates or that use fractal geometry to create various scenes. Also, image generating processes are used in computer animation techniques, such as those employed for movies, electronic gaming and commercials.

### SUMMARY OF THE INVENTION

In accordance with the teachings of the present invention, a system and method are disclosed for automatically creating an image. In one non-limiting embodiment, the image is created for an advertisement that may be targeted to an individual. The method includes identifying image input parameters that the image will be based on, such as a particular product to display, a specific viewer of the image, etc. The method selects image elements from a database of image elements, such as backgrounds, messages, animation, etc., based on the image parameters. The method then creates the image using the image elements where the design and creation of the image is subject to certain rules and constraints that must be followed, such as font size, color schemes, etc.

Additional features of the present invention will become apparent from the following description and appended claims, taken in conjunction with the accompanying drawings.

### BRIEF DESCRIPTION OF THE DRAWING

FIG. 1 is a block diagram showing a method for automatically designing and creating an image using predetermined input parameters, composition rules and constraints, and image elements, according to an embodiment of the present invention.

### DETAILED DESCRIPTION OF THE EMBODIMENTS

The following discussion of the embodiments of the invention directed to a system and method for automatically designing and creating an image is merely exemplary in nature, and is in no way intended to limit the invention or its applications or uses. For example, the discussion below includes creating an image for an advertisement, such as a vehicle advertisement. However, as will be appreciated by those skilled in the art, the system and method for automatically designing and creating an image will have application for other uses and other products.

As will be discussed in detail below, the present invention proposes a process that automatically creates a visual image using an algorithm by selecting image elements from a database based on image input parameters and predefined rules and constraints. The process uses constraint-based, parameter-driven algorithmic control, which is not a process for automatic visual imaging that fills in templates or that uses fractal geometry to create artificial natural scenes, such as water, mountains or clouds. Further, the process does not use computer animation techniques such as those employed for movies, electronic gaming and commercials. Contrary, the images are composed using constraints and rules to depict one or more objects, such as those that might be used for advertising illustrations, corporate brochures, web pages, etc. One example could be a specific vehicle placed on a background of a golf course with a purposeful marketing message and a particular font size and type. The individual elements in the image could be pre-created or graphical math models that are stored in a database, and then extracted, composed and modified per relevant constraints and rules under algorithmic control. Vehicle images would probably be math models that can be scaled, colored, skinned, oriented, etc.

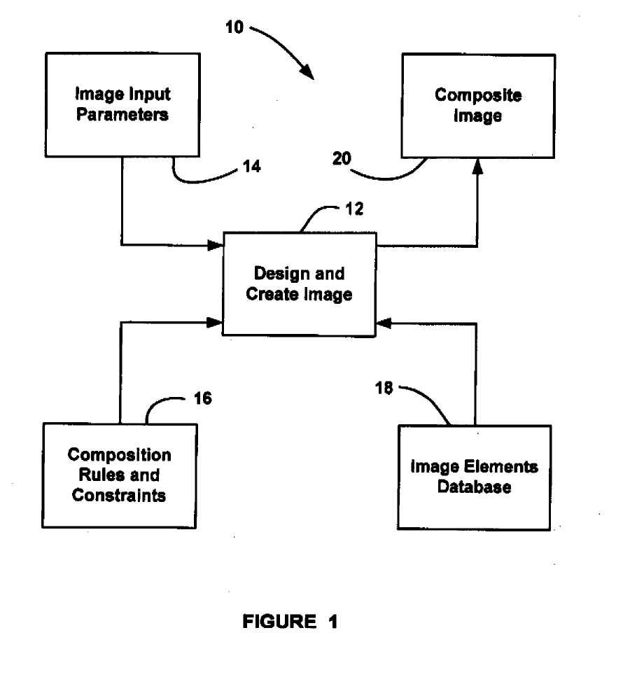

FIG. 1 is a block diagram 10 showing a method for designing and creating an image as discussed and outlined above. The image is designed and created at box 12 using a suitable algorithm that considers and uses image input parameters stored in a database at box 14, composite rules and constraints stored in a database at box 16 and image elements stored in a database at box 18. As will be discussed in further detail below, the input parameters are used to determine which of the image elements from the image elements database at the box 18 will be used to create the image. The selection of the image elements to be placed in the image is based on various rules and constraints from the element database at the box 16 so that the proper combination of elements is selected for the image. Once the image is generated, it is output as a composite image at box 20 for the particular medium that the image will be used. The composite image 20 can be placed in the appropriate medium, such as a particular advertisement, business literature, website page, etc.

The image design and construction at the box 12 begins with certain image input parameters from the box 14. The input parameters can be identified and/or provided by any suitable technique or process that is able to be understood by the algorithm creating the image. In one non-limiting embodiment, a designer of the image will input the parameters directly into the algorithm to create the image. Alternately, a person may be visiting websites looking for a specific product where the web clicks that the person makes will be used to identify the input parameters that will be used to create the image. For example, parameters may indicate a particular trim level of a Malibu sedan, a background, such as a golf course, a parameter value that indicates characteristics of textual messaging that should be placed within the image, etc. Such input parameters may also include information regarding intended recipients of the image. For example, for images that become a web-based banner ad, recipient information might include information about the typical online viewer for the website that will host the advertisement. Such recipient parameter information will then result in an image that is customized to the interests or use of that recipient.

In one specific example, a person may be visiting websites on the Internet where a particular vehicle manufacturer may be advertising its products. For example, the person may be specifically looking for a vehicle, such as on Edmunds.com. Information may be gathered about the person based on what website clicks the person makes. The input parameters can also be determined based on the location of the person and the demographics of the person. The algorithm can employ any suitable statistics analysis consistent with the discussion herein, such as neural networks or Bayesian processes.

The image elements in the database at the box 18 are the building blocks of the composite image 20 that is designed and created, much like building materials are the elements that are used to construct a building. For example, a digital photo in the database might be changed in the composition process so that it matches various constraints or parameter sets for the target viewer. The color of the vehicle might be changed for this purpose, or its orientation on the image, or its proportions in relation to other secondary image elements, such as people. The image elements database at the box 18 could include any suitable element for the purposes described herein, such as photographs, drawings, illustrations of objects, such as vehicles, facts about the objects, backgrounds, such as golf courses, beaches, street scenes, etc., textual messages, such as marketing slogans, corporate communications messaging, etc., secondary object images, such as models, celebrities, ornaments, etc., animations, etc. Some or all of these image elements include control parameters, such as font size, border thickness, object cover, size, orientation, etc.

The composition rules and constraints database at the box 16 may consist of a large number of formalized rules and constraints that govern all aspects of the composition of the image being constructed. There may be a hierarchy of the rules and constraints. That is, some rules and constraints will govern artistic composition, preventing the algorithm, for example, from composing an image with a color combination that is not aesthetically pleasing. For example, it may be known that certain messages and certain audio go better with certain types or models of vehicles and with each other, which could be used as a guideline or a constraint in designing the advertisement. Further, a particular corporation or vehicle manufacturer may have certain design objectives depending on which model or brand of vehicle is being advertised. Some rules and constraints will control textual compositions, including font size, color, font type, contrasts with background, etc.

The rules and constraints hierarchy may consist of rules and constraints that span both functional concepts and physical concepts of the design process. Functional concepts refer to issues concerning the purpose of image, the selection of foreground, background and secondary objects to satisfy the needs and goals of both the owner of the resulting image, and the recipient of that image. Physical concepts refers to issues such as aspect ratios, scaling, composite image real estate allocation, sizing and orientation of objects in the image, selection of two-dimensional and three-dimensional depiction in the image, image layers and object positioning within these layers so that a text message or secondary object does not occlude the primary object being depicted. Another level in the hierarchy manages the interfaces between the functional and physical aspects of composition to ensure consistency of both message and image.

The rules and constraints can be represented in a variety of formalisms, including, but not limited to, first order predicate calculus, syntactical rewrite rules, transition state diagrams, feature structures, frames and slots, mathematical programming, stochastic modeling, numerical optimization and web formalisms.

The general process of creating the image is as follows. The input parameters are manipulated by the primary control algorithm for the design and creation of the image without reference to image output templates. Some parameter values will directly index specific image elements in the database. Other parameters may be ambiguous in the sense that they index more than one image element. In such cases, the processing component will employ a strategy to disambiguate these references either stochastically, or to satisfy either predetermined objectives referenced by composition rules and constraints or dynamic objectives captured by the recipient parameters previously referenced. For example, there may be a predetermined rule that indicates an image is to select fuel economy messaging with some probability and quality messaging with some probability. Alternatively, the intended recipient parameters might indicate that the expected recipient enjoys water sports, so a background of a beach may be favored over a background of a golf course.

The following is an example of how an image for an advertisement may be created based on two potential customers searching for large crossover vehicles between $35,000 and $45,000 on Edmunds.com. The two potential customers are profiled by their clicks in website visits, capturing those profiles in the parameters inputs database 14. In one example, the first customer is believed to be an avid male golfer who frequents golf and sports sites and checks out golf resorts in southeast United States, and is forming his vehicle consideration set. The second customer is believed to be an affluent elderly female home and garden person who visits home and garden craft sites and has been searching dealer inventories. The process first selects one of the stored backdrops that match the particular profile for the individual. The process then selects the vehicle of interest and inserts computer generated images of the vehicle. For example, a Buick Enclave is selected for both customers since both potential customers have searched crossover vehicles between $35,000 and $45,000. A color for the vehicle is selected and a celebrity may be selected for the image, which may both be different for the two potential customers. The image is placed, sized and oriented appropriately for the backdrop. Messages can then be inserted into the image from predefined sales message and facts based on the most important features and measures to the prospects. For example, the golfer who searched regional golf resorts may be interested in fuel economy and the gardener may be interested in financing that is available.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for creating a visual image, said method comprising:
identifying image parameters from which the image is based;
identifying composition rules and constraints for creating the image;
providing a database of image elements used to create the image; and
designing and creating the image using the image input parameters, the composition rules and constraints and certain ones of the image elements.

2. The method according to claim 1 wherein the image is for an advertisement.

3. The method according to claim 2 wherein the advertisement is a vehicle advertisement.

4. The method according to claim 1 wherein providing a database of image elements includes providing photographs, drawings, illustrations of objects, facts about the objects, backgrounds, textual messages, secondary object images and animations.

5. The method according to claim 1 wherein identifying image parameters includes specifically selecting imaging parameters for the visual image.

6. The method according to claim 1 wherein identifying image parameters includes monitoring website clicks that a person makes that are associated with the visual image, and using those website clicks as a basis for the image parameters.

7. The method according to claim 1 wherein identifying composition rules and constraints includes identifying rules and constraints for font style, font size, color schemes, contrasts with background, textual compositions and image orientation.

8. The method according to claim 1 wherein identifying composition rules and constraints includes defining a hierarchy of rules and constraints that includes both functional concepts and physical concepts of the design process, where functional concepts include purpose of messaging, selection of foreground, background and secondary objects, and physical concepts include aspect ratios, scaling, composition image real estate allocation, size and orientation of objects in the image, selection of two-dimensional and three-dimensional depiction in the image, image layers and object positioning.

9. The method according to claim 1 wherein identifying composition rules and constraints includes using a process selected from the group comprising first order predicate calculus, syntactical rewrite rules, transition state diagrams, feature structures, frames and slots, mathematical programming, stochastic modeling, numeral optimization and web formalisms.

10. The method according to claim 1 wherein the method for creating a visual image is done automatically using an algorithm.

11. A method for creating a visual image for an advertisement on a website, said method comprising:
identifying image parameters from which the image is based including monitoring website clicks that a person makes that are associated with the visual image and using those website clicks as a basis for the image parameters;
identifying composition rules and constraints for creating the image including identifying rules and constraints for font style, font size, color schemes, contrasts with background, textual compositions and image orientation;
providing a database of image elements used to create the image where the image elements include photographs, drawings, illustrations of objects, facts about the objects, backgrounds, textual messages, secondary object images and animations; and
designing and creating the image using the image parameters, the composition rules and constraints and certain ones of the image elements that are selected based on the image parameters.

12. The method according to claim 11 wherein the method for creating a visual image is done automatically using an algorithm.

13. The method according to claim 11 wherein the advertisement is a vehicle advertisement.

14. The method according to claim 11 wherein identifying composition rules and constraints includes defining a hierarchy of rules and constraints that includes both functional concepts and physical concepts of the design process, where functional concepts include purpose of messaging, selection of foreground, background and secondary objects, and physical concepts include aspect ratios, scaling, composition image real estate allocation, size and orientation of objects in the image, selection of two-dimensional and three-dimensional depiction in the image, image layers and object positioning.

15. The method according to claim 11 wherein identifying composition rules and constraints includes using a process selected from the group comprising first order predicate calculus, syntactical rewrite rules, transition state diagrams, feature structures, frames and slots, mathematical programming, stochastic modeling, numeral optimization and web formalisms.

16. A system for creating a visual image, said system comprising:
means for identifying image parameters from which the image is based;
means for identifying composition rules and constraints for creating the image;
means for providing a database of image elements used to create the image; and
means for designing and creating the image using the image input parameters, the composition rules and constraints and certain ones of the image elements.

17. The system according to claim 16 wherein the means for identifying image parameters includes means for monitoring website clicks that a person makes that are associated with the visual image, and using those website clicks as a basis for the image parameters.

18. The system according to claim 16 wherein the means for identifying composition rules and constraints means for includes identifying rules and constraints for font style, font size, color schemes, contrasts with background, textual compositions and image orientation.

19. The system according to claim 16 wherein the means for identifying composition rules and constraints includes means for defining a hierarchy of rules and constraints that includes both functional concepts and physical concepts of the design process, where functional concepts include purpose of messaging, selection of foreground, background and secondary objects, and physical concepts include aspect ratios, scaling, composition image real estate allocation, size and orientation of objects in the image, selection of two-dimensional and three-dimensional depiction in the image, image layers and object positioning.

20. The system according to claim 16 wherein providing a database of image elements includes providing photographs, drawings, illustrations of objects, facts about the objects, backgrounds, textual messages, secondary object images and animations.
